(19) United States
(12) Patent Application Publication
(10) Pub. No.: US 2008/0006718 A1
(43) Pub. Date: Jan. 10, 2008

(54) PORTABLE MISTING DEVICE WITH DRINKING SPOUT AND FAN ASSIST

(76) Inventors: Eric Junkel, Mount Prospect, IL (US); Jim Glasgow, Chicago, IL (US); Linda Usher, Chicago, IL (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/779,057

(22) Filed: Jul. 17, 2007

Related U.S. Application Data
(63) Continuation-in-part of application No. 10/974,098, filed on Oct. 27, 2004, now Pat. No. 7,243,860.

(51) Int. Cl. B67D 5/02; A62C 11/00; B05B 1/32

(52) U.S. Cl. 239/333; 239/327; 239/374; 239/541

(57) ABSTRACT

A portable hydration system having a fluid reservoir holding body. A sprayer mechanism including a first orifice projecting from a top of the body for (generating and emitting a fluid mist under pressure therefrom. A reclosable drinking nozzle communicating a second orifice with a further location of the top and having a check valve associated therewith to prevent fluid hack flow. The first and second orifices being in fluid communication with said fluid holding reservoir via a fluid conveying tube extending to a common manifold within the body.

### CROSS REFERENCE TO RELATED APPLICATIONS

The present application claims the priority of U.S. patent application Ser. No. 10/974,098, filed Oct. 27, 2004, for PORTABLE MISTING DEVICE WITH DRINKING SPOUT AND FAN ASSIST.

### BACKGROUND OF THE INVENTION

1. Field of the Invention

The present invention relates generally to a hydration device such as are used by hikers, bikers and other athletes and in order to carry volumes of water in portable fashion. More specifically, the present invention teaches a device which incorporates a misting function to an associated mouthpiece or drinking nipple and in a compact fashion. Additionally, this invention relates generally to an improvement to the design of drinking bottles typically used by athletes and those working or playing outside in hot weather and which is to add a misting function that allows the user to dispense a fine spray of water to the body for external cooling.

2. Description of the Prior Art

The idea of a handheld drinking bottle is ancient and the development of plastics in the 20th century has rendered them cheap, durable and easy to clean. Most typically, such conventional drinking bottles include a drinking nipple attached to the bottle's closure. The user inverts the bottle such that gravity influences the water against the cap end of the bottle for subsequent drinking. The nipple typically defines part of a shutoff valve that prevents leakage when not in use.

Other types of containers utilize a flexible straw to allow the user to suck water out of the bottle and without first inverting the same. Depending upon the existence of the dip tube or not, the user can drink with the bottle upright or inverted.

Athletes often also use misting bottles or fixed misting systems, sometimes in conjunction with fans, and such as to provide cooling in hot weather. According to known physical principles, the misted water readily evaporates and draws heat from the air and the user's skin and clothing.

Addressing the prior art, Walthers U.S. Pat. No. 6,010,034, teaches a combination drinking and spray bottle defining, a nested arrangement of inner and outer containers which likewise establish a nested set of segregated inner and outer chambers for containing separate quantities of liquids with a drinking straw being provided for withdrawing drinking liquid from the outer chamber, and with a manually operated spray device being provided for withdrawing spraying liquid from the inner chamber.

U.S. Pat. No. 5,799,873, issued to Lau, teaches a number of variants of a sprayer combined with a drinking nozzle. Like Walthers, the concept revolves around using a standard sprayer (a trigger sprayer like the Calmar TS-800 in this case) with the means to drink water from the same reservoir. Specifically, a multi-port dispensing system allows the user to either receive a spray of liquid for cooling or a stream of water for drinking. In a preferred embodiment an ejector (spray head) attaches to a body which in turn attaches to a container. Once fully assembled, the user may drink liquid from the container by sucking on the straw protruding from the body. Simultaneously or sequentially with drinking from the straw, the user may receive mist spray from the ejector. Lau '873 teaches the use of check valves, motorized pumps and pressurized reservoirs to produce both automatic and manual misting, water bottle and fountain operations.

Carter, U.S. Pat. No. 6,161,777, also teaches combined misting and drinking from a common supply, in the context of a water misting fan. Specifically, a portable spraying and drinking apparatus with soft fan blades is provided. The spraying apparatus directs a cooling liquid through a nozzle placed in the air stream created by a portable fan. The airflow over wet surfaces increases cooling by speeding evaporation. A separate drinking container can be filled with a beverage and an insulating jacket may be provided around both liquids, Carter therefore teaches separate supplies as in Walthers, with closer alignment of the two reservoirs. In its most refined form, Carter teaches a bottle closure that combines a pushbutton, fingertip pump with a drinking nipple.

Steiner et al., U.S. Pat. No. 5,788,125, teaches a sip and spray fluid container assembly including a bottle with a drinking nipple and sprayer operating from a common reservoir. The sprayer and drinking nipples are arrayed opposite to each other on the reservoir. A bottom located fill port and check valve in the drinking nipple also are taught.

Roppolo, III. U.S. Pat. No. 5,154,317, teaches a large scale version of a portable liquid dispenser reservoir for transporting large quantities of liquid to a remote location and for dispensing upon demand. The liquid dispensing unit provides for the use of a hand truck which supports and carries an insulating and hollow container suitable for retaining a liquid. An intake side of a pump electrically connected to a rechargeable battery draws fluid from within the container and, upon conveying the same to a manifold, distributes the fluid in one of a given number of hoses from which fluid flow is initiated through an associated pressure control switch.

In the main, these aforementioned patents describe inventions that are overly complex or suffer from performance limitations that make it less desirable for the active athlete or others enjoying outdoor activities in the heat. Some inventions require the user to reorient the bottle in his grip to alternately use the drinking and insisting function.

Further, the misting function in each of the above-referenced designs operates in either the upright configuration or inverted configuration, but not both. Further, the exposing of the trigger renders the device less durable and more likely to cause injury. Loss or damage is further increased because of the lack of hand grips or an elastic strap. Some of the above further require the user to touch (such as by rotating or linearly displacing) the drinking nipple in order to operate the sprayer, possibly contaminating it.

### SUMMARY OF THE PRESENT INVENTION

The present invention discloses a portable misting device including a body having a specified three-dimensional shape and size and incorporating a fluid holding reservoir. A fill port is provided for refilling the fluid holding reservoir and is accessible at a selected location of the body, such as the top.

A sprayer mechanism terminates in a first orifice projecting from the top of the body for emitting a fluid mist. A drinking nozzle is provided at a further location of the body and communicates with a second fluid conveying orifice. A manifold communicates the reservoir, such as via a dip tube, to the first and second orifices and in order to simultaneously provide fluid to the sprayer mechanism and drinking nozzle. Additional features include and are not limited to several versions of a pump associated with the sprayer mechanism, a fan incorporated into a top attachable assembly including both the sprayer and drinking nozzle, and the second orifice including a check valve to prevent fluid back flow.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a plan view of a drinking bottle with built in mister according to a first preferred embodiment of the present invention;

FIG. 2 is a sectional illustration in detail of a spray mister mechanism incorporated into the drinking bottle of FIG. 1;

FIG. 3 is a plan view of a combination drinking bottle and spray mister according to a second preferred embodiment of the present invention and in which the drinking nipple and mister are built onto the reservoir closure;

FIG. 4 is a sectional illustration of the manifold and check valve components associated with the drinking bottle of FIG. 2;

FIG. 5 illustrates an alternately configured combination drinking nipple/check valve such as which can be incorporated into the drinking bottle of FIG. 3;

FIG. 5A is an exploded view of the drinking nipple/check valve of FIG. 5;

FIG. 6 is a plan view of a drinking bottle with misting function according to a third preferred embodiment of the present invention and by, which a fan is incorporated into the misting assembly;

FIG. 7 is a first environmental view of the drinking bottle shown in FIG. 1; and

FIG. 8 is an exploded view of the drinking bottle of FIGS. 1 and 7.

### DETAILED DESCRIPTION OF THE PREFERRED EMBODIMENTS

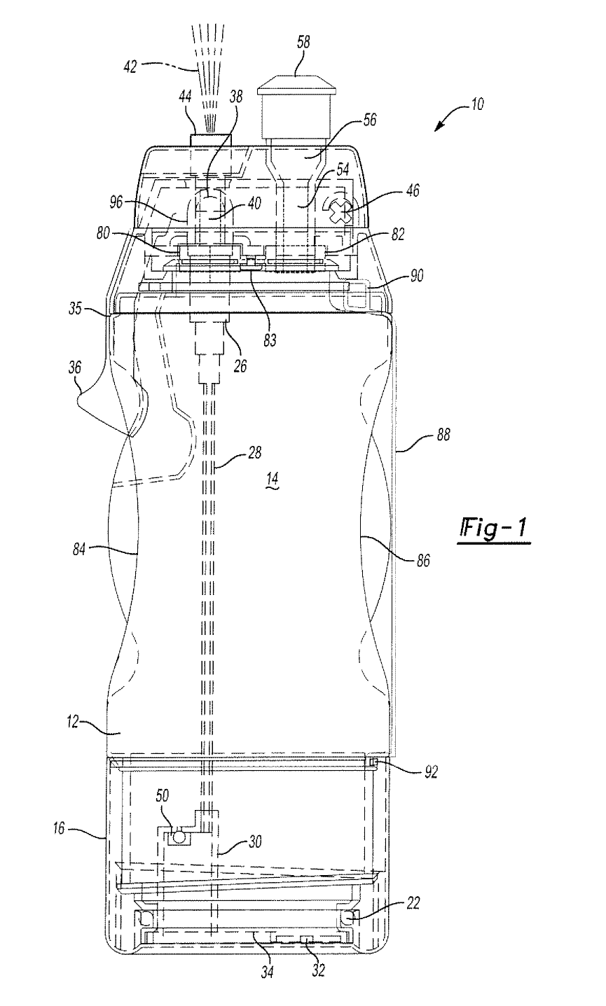

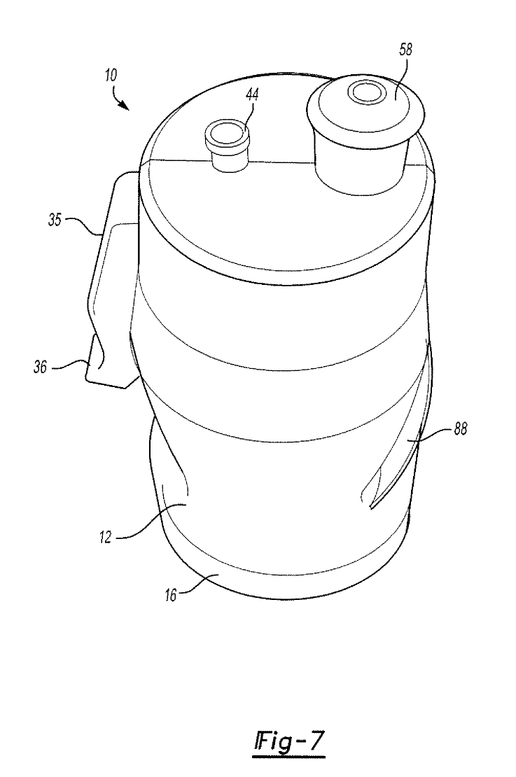

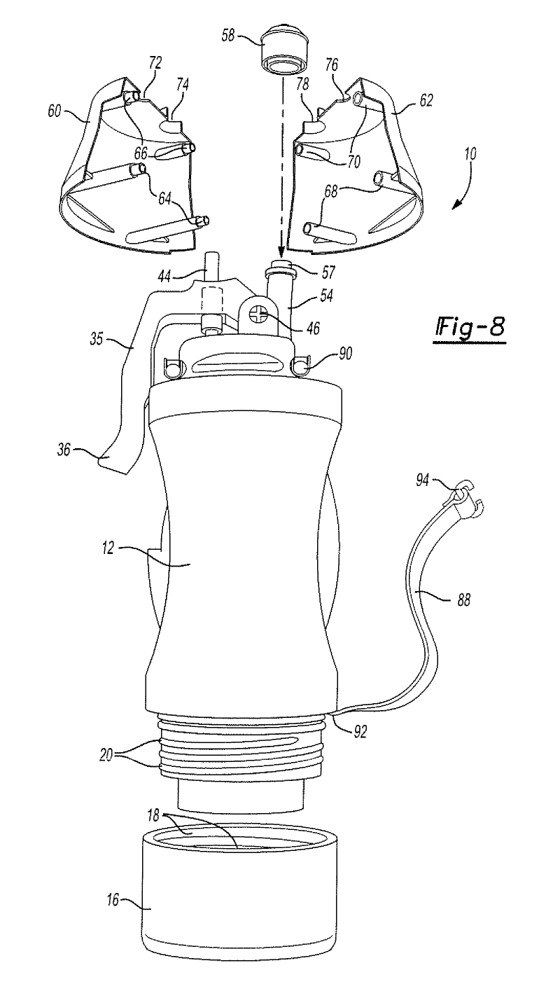

Referring now to FIG. 1, a plan view is shown at 10 of a first embodiment of a portable misting device (also termed a portable hydration system) according to the present inventions. The same variant is also illustrated in the perspective view of FIG. 7 and associated exploded view of FIG. 8.

As previously described, the present invention teaches a device which incorporates a misting function to an associated mouthpiece or drinking nipple in a compact fashion and which is an improvement to the design of drinking bottles typically used by athletes and those working or playing outside in hot weather. In particular the present design adds, to a conventional drinking nipple, a misting function which allows the user to dispense a fine spray of water to the body for external cooling.

A main body 12 of the device 10 is typically constructed of a durable, lightweight and plasticized material, although other material constructions such as a lightweight aluminum and the like are also contemplated. The main body 12 is also shown being generally shaped as a modified cylinder, it also being understood that other three-dimensional shapes and configurations can be employed without departing from the scope of the invention.

Located in a generally central interior section of the main body 12 is a fluid (typically portable form of water or other drinkable beverage) holding reservoir, see as generally referenced at 14 in FIG. 1. The reservoir 14 is provided in the illustrated embodiment with a fill cap 16 which is interiorly threaded, at 18 in FIG. 8, in order to be screwed onto associated exterior threads, at 20 also in FIG. 8, associated with an opened bottom of the main body 12. An O-ring seal 22 is provided at an upper end contact location with the screw/fill cap 16 and, upon first inverting the body 12 in order to fill the reservoir interior 14, subsequently prevents leakage of fluid (not shown) held within the reservoir 14 and upon the cap 16 being reapplied to the body 12.

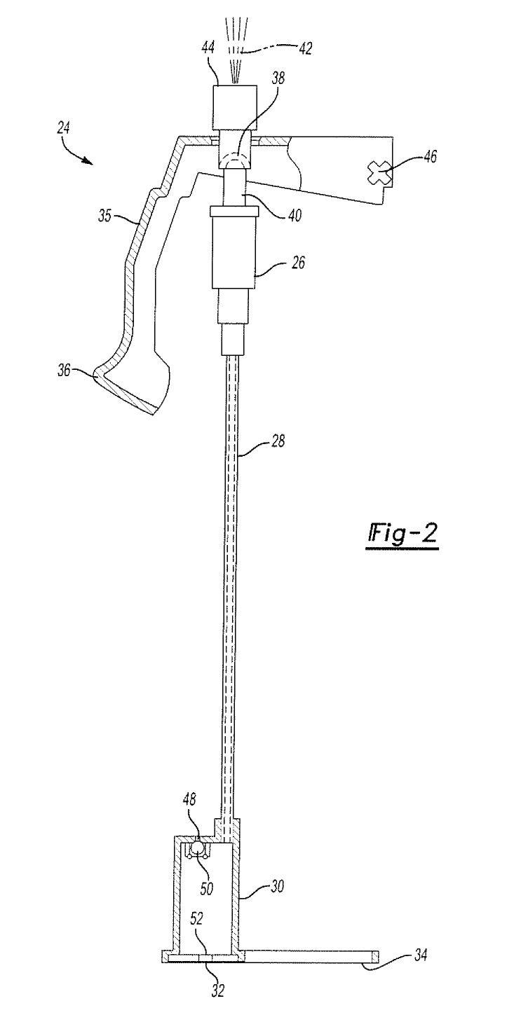

As is also illustrated at 24 in the sectional view of FIG. 2, a spray mister mechanism is provided and which is incorporated into the main body 12 (see again FIG. 1). Lowermost portions of the mister mechanism 24 include a pump 26 and associated dip tube 28, which in turn terminates downwardly in a holding chamber assembly 30 also defining a bottom inlet port 32 and laterally projecting neck guide 34, see in FIG. 1 and which shows the neck guide locating the holding chamber assembly at a bottom end position of the fluid holding reservoir 14.

Upon a user depressing a particularly configured lever 35 with edge defined finger grip 36, actuation of which operates against a cam 38 (or idler bearing as previously noted). The pump 26 (also termed as a piston) is forcibly pushed inward and results in a flow of fluid being influenced up through a discharge tube 40 located atop the pump 26, to commence and create a fine mist/spray, see as illustrated at 42, upon it being emitted from an uppermost disposed nozzle 44 defining a first spray orifice. In the illustrated embodiment, the lever 35 is configured so as to rotate about a fixed pivot 46 at an intermediate location, it being further understood that lever 35 may be redesigned to linearly translate, and which may be advantageous for some applications.

As is again shown in FIG. 1 actuation of the pump 26 causes fluid to be drawn upward via the dip tube 28. A previously noted, the dip tube 26 draws water out of the holding chamber 30. The holding chamber 30 again has the inlet port 32 located on the bottom, its outlet being connected to the dip tube and it is further provided with a small vent hole 48 at the top. The vent hole 48 is used to allow air to bubble out of an emptied holding chamber 30. As long as the holding chamber 38 is located under an associated fluid level defining the reservoir (not seen), it will continue to fill with water.

Upon the user inverting the device 10, most of the fluid within the reservoir 14 will displace toward atop end (now facing downward) and away from the inlet 32 to the dip tube 28, however the fluid located within the holding chamber 30 can still flow into the dip tube 28, thus keeping water available for misting in either orientation. If the vent hole 48 is provided with a ball type check valve 50 (note that the ball needs to be denser than water), then it will plug the vent hole upon the bottle being inverted. Otherwise, the fluid will slowly drain out of the vent hole 48 when inverted.

The holding chamber 30 may the further provided with a loop-like structure to align it within the neck of the fill port (see again neck guide 34), to protect it and to keep it from flopping around inside the bottom interior of the reservoir. The inlet port 32 may be further provided with a filter (see at 52 in FIG. 2) to prevent the pump 26 from becoming clogged by particulates (not shown) which may become entrained within the fluid. Such particulates may be introduced when the bottle is filled or enter via ice made from hard (mineral bearing) water that precipitate out when the water is frozen. The filter element 52 may further be hermetically sealed to the holding chamber 30 by means of such as sonic welding, heat welding or RF (radio frequency) welding.

Also extending from a top of the reservoir 14 is a short channel (or conduit) 54, see FIG. 1, to a check valve 56, shown using the ball type valve. The outlet of the check valve 56 attaches to a drinking nozzle (or nipple) of the type conventionally found on a drinking bottle and usually includes an inner fixed part 57 secured to a top end of the channel 54, with a vertically displaceable openable/closable cap 58 being interengageable with the fixed part 57 in both the opened and closed positions.

In use, the user may invert the device 10 to allow the fluid (e.g. water) to flow past the check valve 56 into the nozzle 58. If placed in the OPEN position (e.g. displaced upwardly relative to the fixed part 57), the fluid will pour or can be sucked out by the user. If the channel 54 is extended downward into the reservoir 14, it will act as an impromptu dip tube (not to be confused with 28), allowing the user to drink while the device is in the upright configuration (as shown in FIG. 1). The check valve 56 further serves to prevent backwash of saliva into the reservoir 14.

A cap is provided to enclose the top of the main body 12, and to provide a clean look for the product and to protect the seals and pumping mechanism. Reference is specifically made to specifically configured cap half sections 60 and 62 in the exploded view of FIG. 8 and which include opposing and inwardly projecting sets of stake portions 64 and 66 for cap section 60 and additional interengaging stake portions 68 and 70 for cap section 62, for assembling the cap sections about the upper components of the sprayer mechanism and associated drinking channel 54. Half circles 72 & 74 and 76 & 78 are associated with the upper ends of the cap sections 60 and 62 in order to define the orifice permitting passageways associated with the mister nozzle 44 and fixed component 57 of the drinking nipple/nozzle 58. Grommets 80 and 82 (see again FIG. 1) may also be used to form seals (at lower end locations of the cap) between the pump body 26 and reservoir 14 as well as short channel conduit 54 as shown in FIG. 1. In this fashion, the sprayer mechanism pump 26 and dip tube 28 can extend downwardly past the lower supporting surface of the cap, whereas the drinking short channel 54 terminates at its lower end within the cap enclosure and is sealed by associated grommet 82.

An additional aperture may be located into the top of the reservoir 14 so that a vent 83 may be installed (as best shown in FIG. 1). The vent 83 is a one way valve that allows air to backfill into the reservoir 14, as fluid is being dispensed in either liquid or misted form out of the reservoir. Without the vent 83, internal suction would prevent water from flowing out.

As shown, additional features include the provision of hand holds 84 & 86 molded into the sides of the bottle/device 10, to facilitate ease of user handling the bottle, especially with sweaty hands. An elastic strap 88 further assists the user in holding the device 10, with the user's hand (not shown) fitting between the strap 88 and the hand holds 84 & 86. As also shown, rings 90, at the top, and 92, at the bottom, of the reservoir 10, interengage associated end defined hook portions, see for example at upper end of strap at 94 in FIG. 8, and in order to retain the elastic strap 94 in place.

Referencing again the finger grip and lever 36, located to the left side of the plan view illustration in FIG. 1, a user again squeezes the finger grip inward, in order to actuate the pump mechanism through the cam 38 and to issue a spray 42 from the nozzle 44 mounted to the discharge tube 40 of M the pump 26. While the spray pattern 42 is shown as being directed in a substantially upward linear pattern, it is further understood that the nozzle 44 can be suitably (re)designed in order to spray to the side of the portable device 10 or other directions in between, as dictated by engineering concerns. To protect the lever 35 and associated finger grip 36 from damage, the lever 35 may alternatively be recessed into the side of the reservoir 14, allowing only the finger grip 36 to protrude.

A cam guide 96 (see again FIG. 1) is provided for ensuring that the misting nozzle 44 translates straight in and out of the pump 26. Also, a pair of idler hearings (not shown) may be mounted to the sides of the nozzle assembly and which operate to roll or slide inside of the linear cam guides to again assist in maintaining the pump piston (not shown) movement in a straight line.

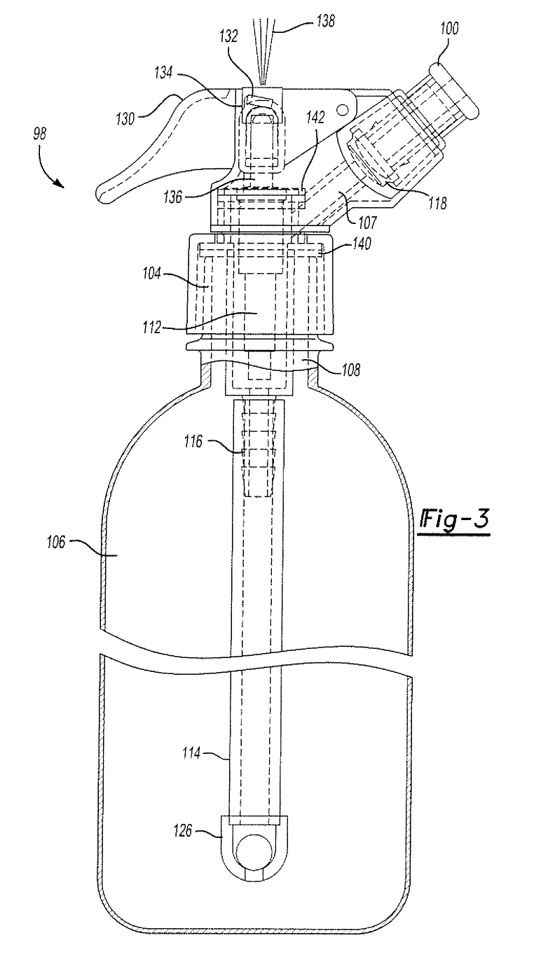

Referring now to FIG. 3, a secondary variant is generally shown at 98 of a portable misting device/portable hydration system according to a second embodiment of the present invention. Unlike the first embodiment 10 of FIGS. 1, 2, 7 and 8, a drinking nozzle 100 and mister assembly, see also at 102 in FIG. 3, are built onto a closure 104 of the interior reservoir defining device, and rather than onto an end of the reservoir opposite the closure (as shown in FIG. 1). This feature allows the drinking/misting unit to be sold as a combined and separate unit apart from the reservoir defining body, see at 106 as shown in FIG. 3, allowing the user to install the unit on any number of styles of bottles with compatible bottle necks/closures 104, these typically again including such as screw caps or the like with interengaging inner and outer threads, although it is further understood that a press fit and twist, e.g. bayonet and tab, arrangement can also be substituted.

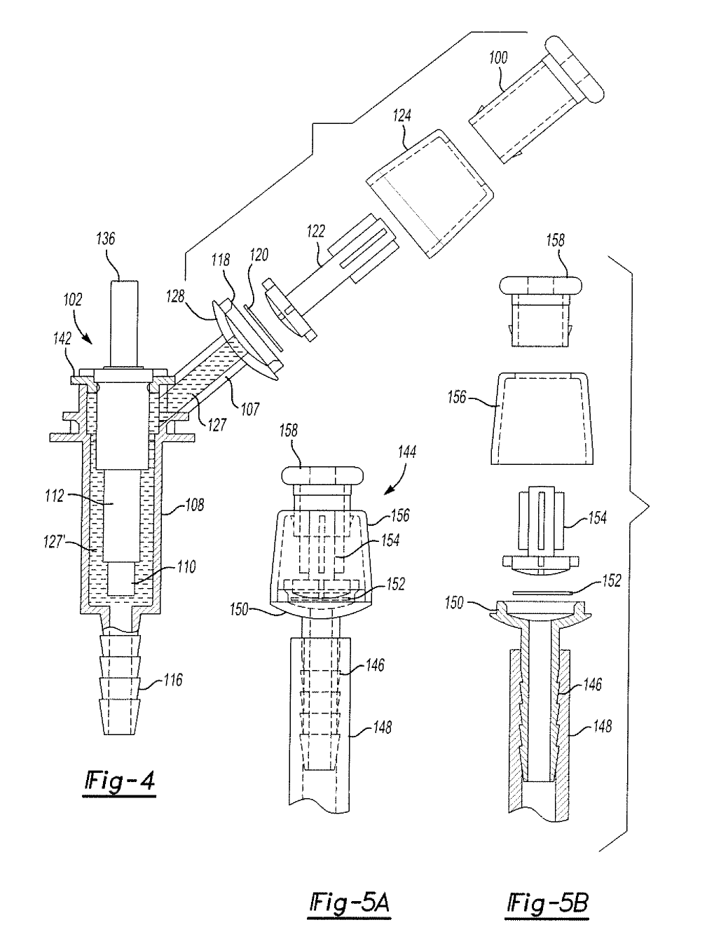

Referencing again FIGS. 3 and 4, a two part manifold sits atop the closure defining opening 104 atop the body defined reservoir 106 and includes an upper manifold 107 and a lower manifold 108. The manifold components surround the pump body, with an inlet 110 to pump 112 being located inside the manifold. The inlet 110 to the manifold is best illustrated in FIG. 4 and draws liquid from the bottom of the reservoir by use of a dip tube 114 secured to the combination manifold assembly via such as a barbed hose fitting 116. The fluid exits the manifold through either the pump 112 or, alternatively, the drinking nozzle 100 via a check valve.

Reference in particular is made to FIG. 4 and which illustrates in partially exploded fashion the features of a check valve seat 118, with which is engaged an associated flapper 120 and a gate 122 to the mouth operated valve. The flapper 120 operates as the gate to the check valve associated with the valve seat 118. A valve shroud 124 covers the gate 122 and provides a seating location for the displaceable nozzle 100.

As further shown in FIG. 3, the dip tube 114 fits over the barbed hose fitting 116 on the lower end of the manifold assembly (108). The lower end of the dip tube 114 is outfitted with a check valve 126 (ball type in the illustrations). According to this arrangement, the user can prime the system by sucking a small amount of water/fluid up into the manifold 108 through the drinking nipple/nozzle 100, with the check valve 126 holding the water for use by the pump 112 or for the user to drink.

The drinking nipple 100 shown in the illustrations of FIGS. 3 and 4 also doubles as a shutoff valve and, upon being pushed into the valve shroud 124, the valve gate 122 plugs the opening in the nipple. In the referenced design, the plug or valve gate 122 of the shutoff valve doubles as a retainer for the flapper 120 component of the check valve. This, and upon the user sucking fluid/water, see at 127 in FIG. 4, through the nipple 100, the flapper 120 is caused to pull away from a bowl-shape component 128 (see again FIG. 4) of valve seat 118 that defines a part of the upper manifold 107. Upon the user stopping vacuum inducing sucking, the water 127, under the influence of gravity or a vacuum in the reservoir, pulls the flapper 120 against the seat 118, preventing flow back into the main body defining reservoir 106. This again prevents a users saliva from contaminating the water in the reservoir.

The operation of the pump 112 in the embodiment of FIG. 3 is otherwise similar to that previously described in association with the embodiment of FIG. 1. A lever 130 (FIG. 3) pivots against the enclosure (itself mounted the reservoir closure) and an associated cam surface 132 on the lever 130 operates against cam surface on a nozzle 134. The nozzle 134 in turn pushes against a pump discharge tube 136 (both FIGS. 3 and 4) and associated piston (not shown). In this fashion, pressurized fluid (e.g. water) is emitted through the nozzle 134 into a fine mist, see as illustrated at 138, above the mister. Additional features associated with the design will also typically include a gasket 140 (FIG. 3) between the (lower) manifold 108 and the reservoir neck/closure 104, and a grommet 142 to seal between the pump body and manifold.

As is also known, most carbonated beverage bottles sold in the USA use a common threaded neck finish on the bottles, about 28 mill outside diameter. PCO-1810 specification. As shown in FIG. 3, the screw collar (neck closure 104) incorporating this neck finish holds the manifold tight to the gasket 140, between the lower manifold 108 and the rim of the bottle.

It is also contemplated that a larger neck can be substituted in a revised design and (exhibiting a 38 mm outside diameter) as used on larger bottles of drinking water, as well as a 62 mm finish used on large polycarbonate bottles of around 1 liter capacity as sold by Nalgene and others for athletes and campers. In such alternate applications, the trigger (i.e. lever) would have to be lengthened to render it more accessible from the edge of a relatively widened cap. As with the first preferred embodiment, the ergonomics associated with exterior gripping locations of the device 106 are important, as the user will want to hold the bottle in one hand, typically while operating the sprayer or drinking.

With reference again to FIG. 4, it is again noted that the water filled sections of the manifold, upper 127 as well as lower at 127′, are shown with cross hatching. The pump 112 is again illustrated substantially immersed within the fluid/water. Additionally, the (lower) manifold 108 is mostly enclosed by the neck of the bottle (closure 104) or reservoir. Although not illustrated in FIG. 3, it is also noted that a holding chamber similar to the first embodiment could be used to the same effect as on the first embodiment, but with the added advantage that both misting and drinking are possible in either orientation as the drinking nipple and pump share a common supply.

Referring now to FIGS. 5a and 5b both assembled and exploded views are shown of a different application of the drinking nipple/check valve technology, see at 144, in a further alternate embodiment of the drinking bottle/mister. The upper manifold 106 previously illustrated in FIG. 4 is modified to eliminate all features, with the exception of the check valve 126. A barbed hose fitting 146 feeds water from a flexible tube 148 (e.g. one attached to a hydration pack) to a check valve (see again seat 150, flapper 152, flapper retainer 154 and covering valve enclosure 156. The user sticks on the nipple to draw water out of the flexible tube 148 and the check valve assembly prevents back flow of saliva into the supply tube. The user can use their teeth in order to engage an outer radially protruding end location associated with a nipple 158. e.g. again mounted in linearly translating and fluid communicating fashion with the valve enclosure 156, and to permit opening and drinking. Additionally, and when the nipple 158 is depressed closed, water will not leak out.

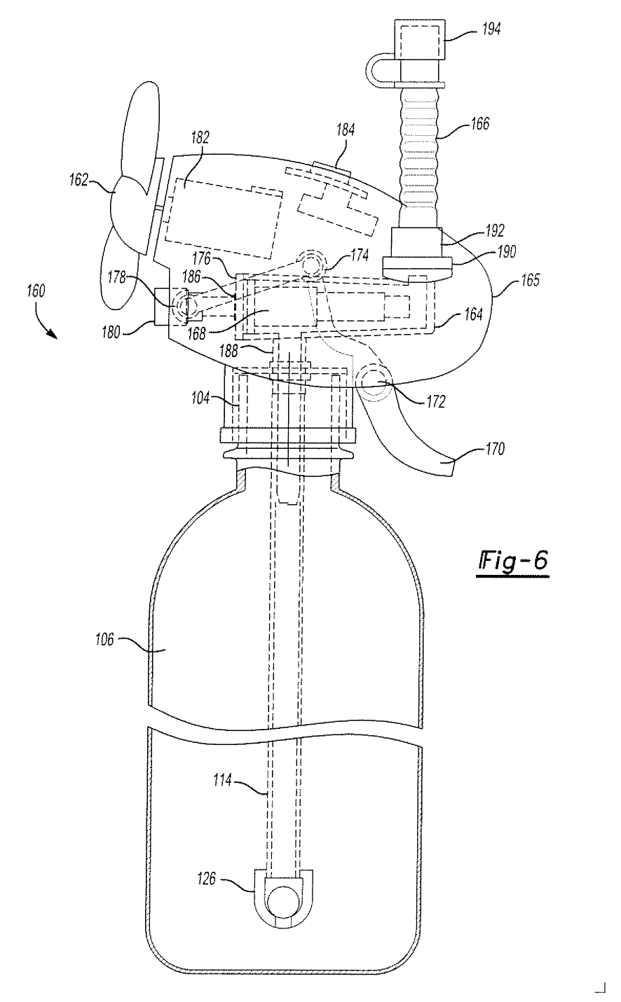

Finally, and now referring to FIG. 6, an embodiment is illustrated at 160 and which shows another embodiment of the drinking bottle with misting function where a fan 162 is added to the water misting function. According to this variant, a manifold 164 is incorporated into an enclosure 165 and which supplies water to an associated drinking tube 166, a pump 168 being located above the neck closure, again referenced at 104, of the bottle 106, and rather than within as in the previously disclosed embodiments.

In application, the user squeezes a trigger 170 that pivots against the enclosure 164. The trigger arm extends past an associated pivot 172 and terminates in a rotational joint 174 with a link 176. An opposite end, at 178, of the link 176 is in turn rotationally attached to a nozzle 180. Upon pulling the trigger 170, the resulting translation and small amount of rotation of the link 176 in turn, pulls (displaces) the nozzle 180 (mounted to the discharge tube of the piston pump) inward into the pump 168, thus generating a spray of liquid into the air stream created by the motor driven fan blades 162 (impeller). A motor 182 is driven by batteries arranged inside the enclosure (not shown) and a switch 184 controls a generated electrical current to the motor 182, e.g. to turn ON and OFF the device.

It is additionally noted that the pump 168 is mostly entrained within the manifold 164, a gasket 186 sealing the open end of the manifold 164 to the upper end of the pump 168. In use, water enters from a fitting 188 located on a side of the manifold 164 that is attached to the dip tube 114. A portion of the liquid/water goes into the inlet of the pump 168 (again enclosed by the manifold 164) whereas, an additional volume transits to the drinking straw 166 via flapper type check valve, see as further collectively referenced at 190. An outlet 192 of the flapper valve connects to the drinking straw 166, and which may further have a closure 194 that is tethered thereto. It is also envisioned that a bite valve (nipple) as referenced in one of the earlier embodiments can be substituted for the closure 194.

Accordingly, the present design allows the manifold 164 to be molded as a single piece. The design can also better accommodate narrower bottle necks or larger pump diameters that would otherwise not fit in the bottle neck. The required seals are at a minimum and the designs are well known in the art.

The preceding disclosure provides a detailed background into a new way of making a water bottle with misting function that offers many improvements over the prior art. Further, the relevant prior art is disclosed and analyzed for similarities and dissimilarities with the present invention. Then the invention has been presented in detail.

The inventor believes that the present invention is unique and novel and it worthy of a letters patent covering its basic technology and improvements.

Having described my invention, other and additional preferred embodiments will become apparent to those skilled in the art to which it pertains, and without deviating from the scope of the appended claims

I claim:

1. A portable hydration system formed by an assembly comprising
a body having a body portion and a top portion,
said body portion accommodating a fluid holding reservoir,
said top portion provided with a first orifice, said first orifice having spray mist means associated therewith for generating and emitting a fluid mist tinder pressure therefrom,
said top portion further including a second orifice, said second orifice provided with a drinking nozzle associated therewith,
said first and second orifices being in fluid communication with said fluid holding reservoir via a manifold, said manifold being in fluid communication with said fluid holding reservoir via a fluid tube,
and said second orifice having a check valve associated therewith to prevent fluid back flow.

2. The portable hydration system as set forth in claim 1 above, wherein said fluid spray mist means comprises a pump, said pump including a pump piston operating within a pump chamber, a fluid tube interconnecting said pump with said fluid holding reservoir, and means for reciprocating said pump piston to draw fluid into said pump chamber and deliver the fluid to said first orifice which emits a fluid mist.

3. The portable hydration system as set forth in claim 2 above, wherein said means for operating said pump piston comprises a manual lever.

4. The portable hydration system as set forth in claim 3 above, wherein said body includes a lever recess formed therein and said lever is at least partially recessed within said lever recess.

5. The portable hydration system as set forth in claim 4 above, wherein said lever is mounted at a pivot point within said top portion and includes a link and linear track to guide the motion of the pump piston incident to the pumping action.

6. The portable hydration system as set forth in claim 1 above, wherein said fluid tube terminates within a fluid chamber positioned within said fluid reservoir, said fluid chamber having a fluid inlet at one end and a vent at the opposed end thereby to permit operation of said hydration system in the inverted position.

7. The portable hydration system as set forth in claim 6 above, further comprising said vent being provided with a check valve to prevent fluid backflow in the inverted position.

8. The portable hydration system as set forth in claim 2 above, wherein said manifold is positioned in the top portion of said body and is in fluid communication with said pump thereby to provide fluid to said pump) to create a spray mist through said first orifice, and in fluid communication with said second orifice to provide drinking fluid to said nozzle.

9. The portable hydration system as set forth in claim 8 above, wherein said fluid tube is provided with a check valve thereby to prevent fluid back flow and allow the hydration system to operate.

10. The portable hydration system as set forth in claim 1 above, wherein said fluid holding reservoir is provided with an air vent thereby to allow air to backfill into said reservoir as fluid is withdrawn therefrom.

11. The portable hydration system as set forth in claim 1 above, wherein said body includes a fill port, a fill cap is provided which engages over said fill port to sealingly engage and close said fluid holding reservoir.

12. The portable hydration system as set forth in claim 1 above, wherein said body portion is formed with an upper neck, said upper neck including threads formed thereon, and said top portion includes a threaded cap adapted to threadingly engage said neck thereby to join said top portion to said body, said neck portion forming a fill port for said fluid holding reservoir.

13. The portable hydration system as set forth in claim 1 above, wherein said body portion includes handholds formed therein thereby to provide a gripping surface for the user thereof.

14. The portable hydration system as set forth in claim 13 above, wherein said body further includes a hand strap mounted thereon and positioned in operative relationship with said handholds to facilitate the gripping of said body.

15. The portable hydration system as set forth in claim 1 above, wherein a power driven fan unit is secured to said top portion and is positioned to receive the fluid mist from said first orifice into an air stream created by said fan.

16. The portable hydration system as set forth in claim 6 above, wherein said fluid inlet includes a filter element to filter particulates from the fluid in said reservoir.

17. A portable misting device, comprising:
a body having a specified three-dimensional shape and size and incorporating a fluid holding reservoir;
a fill port for refilling said fluid holding reservoir accessible at a selected location of said body;
a sprayer mechanism terminating in a first orifice projecting from said body for emitting a fluid mist;
a drinking nozzle at a further location of said body and communicable with a second fluid conveying orifice;
a manifold communicating said reservoir to said first and second orifices in order to simultaneously provide fluid to said sprayer mechanism and said drinking nozzle.

18. The portable misting device as described in claim 17, further comprising a fluid conveying tube extending from said manifold into said reservoir.

19. The portable misting device as described in claim 17, said second orifice further comprising a check valve to prevent fluid back flow.

20. A drinking bottle, comprising:
a body having a specified three-dimensional shape and size auld incorporating a fluid holding reservoir;
a fill port for refilling said fluid holding reservoir accessible at a selected location of said body;
an upper end of said body being enclosed by a cap, said body incorporating a sprayer mechanism terminating in a first orifice projecting from a top surface of said cap and for emitting a fluid mist, said sprayer mechanism further comprising a pump which draws fluid from said reservoir via a dip tube extending downwardly from said cap into said fluid reservoir body; and
a drinking nozzle arranged at a further top surface location of said cap and communicable with a second offset and fluid conveying orifice which extends vertically within said cap and terminates in a bottom end location associated with said cap above said fluid holding reservoir, fluid being conveyed to said drinking nozzle upon inverting said body from a first position to a second position.

21. The portable misting device as described in claim 20, said sprayer mechanism further comprising a manually operated pump including a lever recessed into said reservoir defining body.

22. The portable misting device as described in claim 21, further comprising said lever rotating on a pivot fixed to a guide secured to said cap closure.

23. The portable misting device as described in claim 20, said dip tube terminating in a holding chamber for maintaining fluid at an entry to said dip tube upon inverting said body.

24. The portable misting device as described in claim 23 said holding chamber further comprising an inlet at a lower end and a vent hole at an upper end.

25. The portable misting device as described in claim 20, said fluid holding reservoir further comprising a top end positioned vent to allow air to backfill said reservoir as fluid is progressively emptied.

26. The portable misting device as described in claim 20, said body having a specified shape and size and further comprising exterior hand holds for each of gripping.

27. The portable misting device as described in claim 26, said fluid holding reservoir further comprising an elastic strap connecting at first and second ends to locations associated with said body and to assist the user with gripping said body.

28. A mouth operated check valve assembly for use with a portable hydration pack, comprising:
a fluid communicating body including a check valve and a surrounding enclosure;
a hose fitting engaging with a remote end of a flexible tube in turn extending from the hydration pack for communicating fluid to said check valve; and
a nipple mounted in linearly translating and fluid communicating fashion with respect to said valve enclosure such that, and upon a user engaging and linearly displacing an outer radially projecting location of said nipple from a sealed closed position to a displaced open positions fluid flow is permitted through said check valve and nipple while preventing backflow of saliva into said hose fitting.

29. The mouth operated check valve assembly as described in claim 28, said check valve exhibiting a specified shape and size and further comprising a seat within which is supported a flapper.

30. The mouth operated check valve assembly as described in claim 29, said check valve further comprising a flapper retainer inter-disposed within said valve enclosure and between said nipple and said flapper.
